(19) United States
(12) Patent Application Publication
(10) Pub. No.: US 2011/0183091 A1
(43) Pub. Date: Jul. 28, 2011

(54) HOUSING FOR ELECTRONIC DEVICE AND METHOD OF FABRICATING THE SAME

(75) Inventors: YONG-GANG ZHU, Shenzhen City (CN); DA-WEI DING, Shenzhen City (CN); GUI-YUN YANG, Shenzhen City (CN); XIN-WU GUAN, Shenzhen City (CN); CHAO-HSUN LIN, Taipei (TW); WU-ZHENG OU, Taipei (TW)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/908,969

(22) Filed: Oct. 21, 2010

(30) Foreign Application Priority Data
Jan. 26, 2010 (CN) 201010300735.8

(51) Int. Cl. C23C 4/12; B05D 3/12; C23C 4/10; B32B 15/02

(52) U.S. Cl. 428/34.6; 427/330; 427/236; 427/453

(57) ABSTRACT

A housing for an electronic device includes a metal substrate and a ceramic coating directly formed on at least portions of the substrate, the coated portions of the substrate having a rough surface. A method for fabricating the housing comprises roughening predetermined portions of the substrate; thermally spraying a ceramic coating on the roughened portions of the substrate, fixing the substrate on a tool having cold water circularly running there within during the thermal spraying; and grinding and polishing the ceramic coating.

### BACKGROUND

1. Technical Field

The present disclosure relates to housings for electronic devices and a fabrication method thereof.

2. Description of Related Art

Metals such as stainless steel, aluminum alloy, magnesium alloy, or titanium alloy, are usually applied for shells of portable electronic devices such as MP3 players, personal digital assistances (PDAs), and mobile phones.

Metal shells are usually electroplated or sprayed by paint to form decorative layers. However, these decorative layers have insufficient wear-resistance.

Therefore, there is room for improvement within the art.

### BRIEF DESCRIPTION OF THE DRAWINGS

Many aspects of the present housing and fabrication method thereof can be better understood with reference to the drawings. The components in the drawings are not necessarily drawn to scale, the emphasis instead being placed upon clearly illustrating the principles of the present housing and fabrication method thereof.

FIG. 1 is a schematic cross-section view of a housing according to a first exemplary embodiment.

FIG. 2 is a schematic cross-section view of a metal substrate of a housing according to a second exemplary embodiment.

FIG. 3 is a schematic view showing one manufacturing process in the method of forming a ceramic coating on the metal substrate according to the second exemplary embodiment.

FIG. 4 is a schematic cross-section view of the housing according to the second exemplary embodiment.

### DETAILED DESCRIPTION

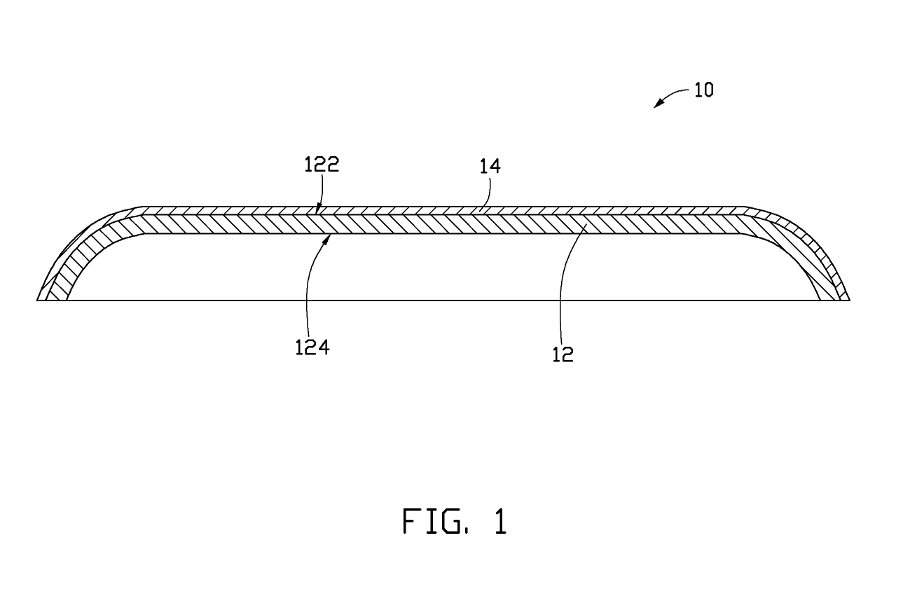

FIG. 1 shows a housing 10 for electronic devices (such as mobile phones) according to a first exemplary embodiment. The housing 10 includes a metal substrate 12 and a ceramic coating 14 formed on the substrate 12.

The substrate 12 may be stainless steel, aluminum, aluminum alloy, magnesium, magnesium alloy, or titanium alloy. The substrate 12 may have a thickness of about 0.4 mm to about 0.6 mm. In this exemplary embodiment, the substrate 12 may be stainless steel and have a thickness of about 0.5 mm. The substrate 12 has an outer surface 122 and an opposite inner surface 124. The outer surface 122 is roughened and has a roughness (Ra) of about 1.3 μm to about 2.0 μm.

The ceramic coating 14 is directly formed on the entire outer surface 122. The ceramic coating 14 may be comprised of an oxide ceramic, such as aluminum oxide (Al₂O₃), ferroferric oxide (Fe₃O₄), or titanium oxide (TiO₂). Since the above referred materials have different colors, the material comprising the ceramic coating 14 may be selected according to a desired color. The ceramic coating 14 has a surface roughness (Ra) of about 0.1 μm to about 0.3 μm, and has a thickness of about 0.12 mm to about 0.14 mm.

An exemplary method for making the housing 10 may include the following steps.

A metal substrate 12 is provided. The substrate 12 has the outer surface 122 and the inner surface 124.

The outer surface 122 may be roughened, for example by sandblasting. Exemplary materials of sandblasting material include silicon carbide, ferrochromium alloy, copper ore, ceramic, alumina and glass. In this exemplary embodiment, silicon carbide particle of 60 mesh size is used for the blasting. The outer surface 122 processed by this step achieves a roughness (Ra) of about 1.3 μm to about 2.0 μm.

A ceramic coating 14 is formed on the outer surface 122 by thermal spraying, such as flame spraying or plasma spraying. It may be preferable to implement the thermal spraying approximately 4 hours after the roughening step. An oxide ceramic material such as aluminum oxide (Al₂O₃), ferroferric oxide (Fe₃O₄), or titanium oxide (TiO₂) may be sprayed to form the ceramic coating. Because the substrate 12 has a small thickness of about 0.4 mm to about 0.6 mm and may be overheated and deformed during the thermal spraying, the substrate 12 may be fixed on a tool having cold water circularly running there within to cool and prevent the substrate 12 from deforming. The ceramic coating 14 has an initial surface roughness (Ra) of about 2.1 μm to about 2.3 μm.

The ceramic coating 14 is ground and polished to achieve a surface roughness of about 0.1 μm to about 0.3 μm. The grinding and polishing process may include the following steps:

The substrate 12 with the ceramic coating 14 is preliminary ground by sandblasting to remove the outermost rough layer of the ceramic coating 14. An abrasive belt having pyramidal carborundum grain attached may be used. During the grinding, cold water may be sprayed on the substrate 12 to prevent deformation. The preliminary ground ceramic coating 14 has a surface roughness (Ra) of about 1.0 μm to about 1.4 μm.

The preliminary ground ceramic coating 14 is finely ground to wipe off the trace on the ceramic coating 14 produced by the preliminary grinding. This step is similar with the preliminary grinding except that an abrasive belt having alumina grain and not carborundum grain attached is used in this step. The finely ground ceramic coating 14 has a surface roughness (Ra) of about 0.5 μm to about 0.8 μm.

A rock grinding process may be used to remove the trace on the ceramic coating 14 produced by the fine grinding. This step can be carried out in a rock grinder using a conical abrasive. The rock ground ceramic coating 14 achieves a surface roughness (Ra) of about 0.1 μm to about 0.3 μm.

The substrate 12 with the ceramic coating 14 may be further processed by roll grinding to improve the brightness of the ceramic coating 14. Walnut shell powder may be used as the abrasive.

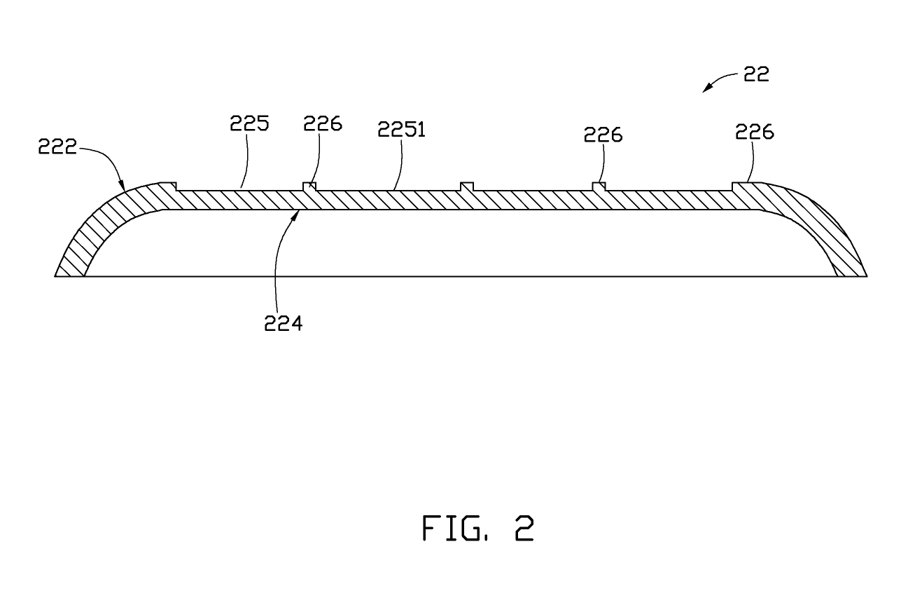

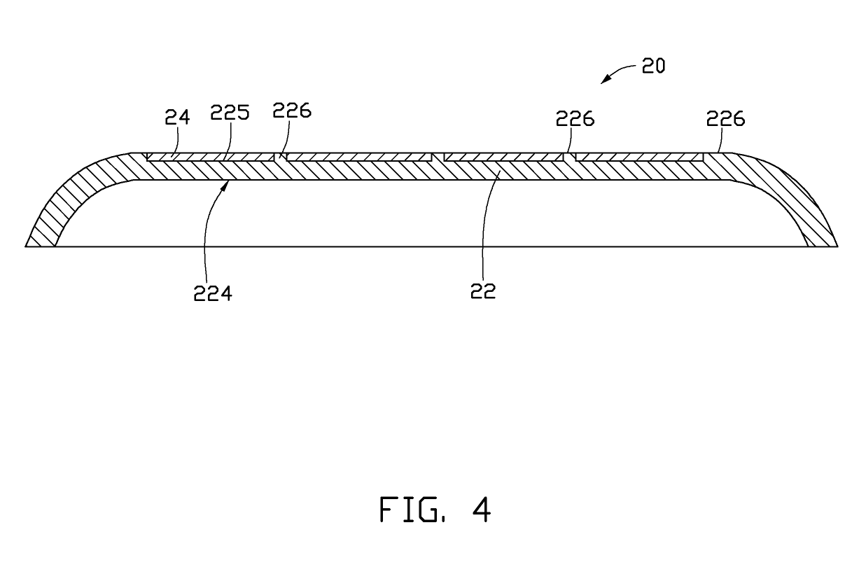

FIG. 4 shows a housing 20 for electronic devices according to a second exemplary embodiment. The housing 20 which is similar with the housing 10 and includes a metal substrate 22 and a ceramic coating 24 formed on the substrate 22. Referring to FIG. 2, the substrate 22 has an outer surface 222 and an opposite inner surface 224. The difference to the first exemplary embodiment includes the outer surface 222 has recesses 225 and protrusions 226. The bottoms 2251 of the recesses 225 have a surface roughness (Ra) of about 1.3 μm to about 2.0 μm. The ceramic coating 24 is formed in the recesses 225. The ceramic coating 24 is ultimately coplanar with the protrusions 226 to cooperatively form the exterior surface of the housing 20. The ceramic coating 24 may form patterns, logos, or characters on the housing 20.

An exemplary method for making the housing 20 may include the following steps.

A metal substrate 22 is provided. The substrate 22 has the outer surface 222 and the inner surface 224.

Predetermined portions of the outer surface 222 are etched by, for example chemical etching or laser etching, to form recesses 225. The other portions of the outer surface 222 not etched form the relative protrusions 226. In this exemplary embodiment, chemical etching is used.

The recesses 225 may be processed by sandblasting to increase the roughness of their bottoms 2251. Because the bottoms 2251 of the recesses 225 may have not enough roughness for facilitating the bonding between the subsequently formed ceramic coating 24 and the substrate 22, the sandblasting process may increase the roughness of the recesses 225. The sandblasted bottoms achieve the roughness (Ra) of about 1.3 μm to about 2.0 μm.

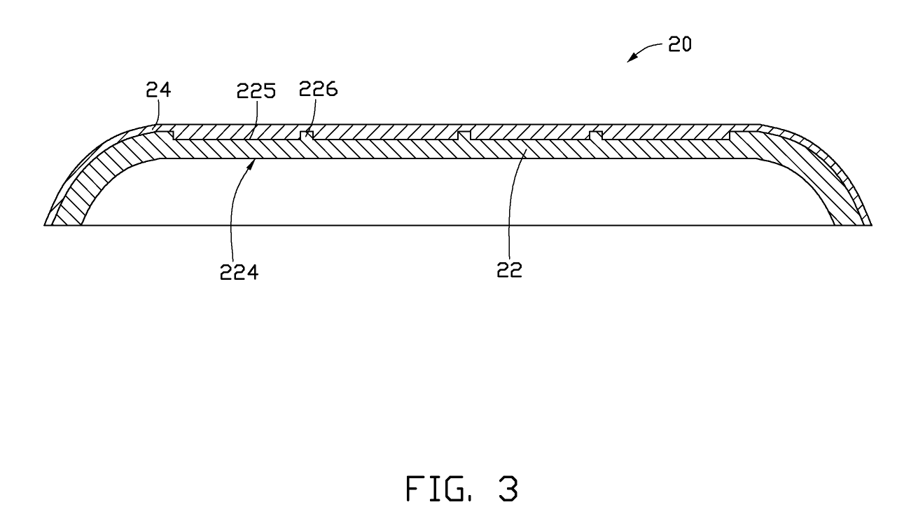

Referring to FIG. 3, a ceramic coating 24 is formed on the substrate 22 using a method similar with the method for forming the ceramic coating 14 in the first exemplary embodiment. The ceramic coating 24 covers the entire outer surface 222, including all the recesses 225 and the protrusions 226.

The ceramic coating 24 is ground and polished to achieve a surface roughness of about 0.1 μm to about 0.3 μm. The grinding process may include preliminary grinding, fine grinding, rock grinding, and roll grinding which are carried out in sequence similar with the first exemplary embodiment. Unlike the first exemplary embodiment, the preliminary grinding processing removes the outermost rough layer of the ceramic coating 24 and also exposes the protrusions 226. Therefore, the exterior surface of the housing 20 is comprised of two distinct materials, metal and ceramic, and patterns or logos may be formed thereby.

The exposed protrusions 226 may be further processed by sandblasting to achieve a matted appearance, thus the ceramic coating 24 is noticeable.

It is to be understood, however, that even though numerous characteristics and advantages of the present exemplary embodiments have been set forth in the foregoing description, together with details of the structures and functions of the exemplary embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A housing for electronic device, comprising:
a metal substrate; and
a ceramic coating directly formed on at least portions of the substrate, the coated portions of the substrate having a rough surface.

2. The housing as claimed in claim 1, wherein the portions of the substrate coated with the ceramic coating having a surface roughness of about 1.3 μm to about 2.0 μm.

3. The housing as claimed in claim 2, wherein the substrate has an outer surface and an opposite inner surface, the ceramic coating formed on the entire outer surface.

4. The housing as claimed in claim 2, wherein the substrate has an outer surface and an opposite inner surface, the outer surface has recesses and protrusions, the ceramic coating is formed in the recesses and coplanar with the protrusions.

5. The housing as claimed in claim 1, wherein the ceramic coating is comprised of an oxide ceramic material.

6. The housing as claimed in claim 5, wherein the oxide ceramic material is selected from the group consisting of aluminum oxide, ferroferric oxide, and titanium oxide.

7. The housing as claimed in claim 1, wherein the ceramic coating has a thickness of about 0.12 mm to about 0.14 mm.

8. The housing as claimed in claim 1, wherein the ceramic coating has a surface roughness of about 0.1 μm to about 0.3 μm.

9. The housing as claimed in claim 8, wherein the substrate is stainless steel, aluminum, aluminum alloy, magnesium, magnesium alloy, or titanium alloy and the substrate has a thickness of about 0.4 mm to about 0.6 mm.

10. The housing as claimed in claim 9, wherein the substrate is stainless steel and has a thickness of about 0.5 mm.

11. A method for making a housing for electronic device, comprising:
providing a metal substrate;
roughening predetermined portions of the substrate;
thermal spraying a ceramic coating on the roughened portions of the substrate, the substrate being fixed on a tool that cools the substrate during the thermal spraying; and
grinding and polishing the ceramic coating.

12. The method as claimed in claim 11, wherein the roughening process used sandblasting and the roughened portions have a surface roughness of about 1.3 μm to about 2.0 μm.

13. The method as claimed in claim 12, wherein the substrate has an outer surface and an opposite inner surface, the entire outer surface is roughened, and the ceramic coating is formed on the entire outer surface.

14. The method as claimed in claim 13, wherein the grinding and polishing process includes preliminary grinding the ceramic coating by sandblasting to remove the outermost rough layer of the ceramic coating, the preliminary ground ceramic coating has a surface roughness of about 1.0 μm to about 1.4 μm.

15. The method as claimed in claim 14, wherein the grinding and polishing process further includes the following steps carried out in sequence: fine grinding, to achieve a surface roughness of about 0.5 μm to about 0.8 μm; rock grinding, to achieve a surface roughness of about 0.1 μm to about 0.3 μm; and roll grinding to improve the brightness of the ceramic coating.

16. The method as claimed in claim 12, wherein the substrate has an outer surface and an opposite inner surface, the outer surface has recesses and protrusions, the bottoms of the recesses are roughened, and the ceramic coating is formed in the recesses and coplanar with the protrusions.

17. The method as claimed in claim 16, wherein the grinding and polishing process includes preliminary grinding the ceramic coating by sandblasting to remove the outermost rough layer of the ceramic coating and expose the protrusions, the preliminary ground ceramic coating has a surface roughness of about 1.0 μm to about 1.4 μm.

18. The method as claimed in claim 17, wherein the grinding and polishing process further includes the following steps carried out in sequence: fine grinding, to achieve a surface roughness of about 0.5 μm to about 0.8 μm; rock grinding, to achieve a surface roughness of about 0.1 μm to about 0.3 μm; and roll grinding.

19. The method as claimed in claim 16, wherein the recesses are formed by etching.

20. The method as claimed in claim 11, wherein the thermal spraying is flame spraying.
